(19) United States
(12) Patent Application Publication
(10) Pub. No.: US 2023/0167904 A1
(43) Pub. Date: Jun. 1, 2023

(54) SEALING DEVICE

(71) Applicant: NOK CORPORATION, Tokyo (JP)

(72) Inventors: Toshiki WATANABE, Fukushima (JP); Tomoyuki NUMATA, Fujisawa (JP)

(21) Appl. No.: 17/922,112

(22) PCT Filed: May 24, 2021
(86) PCT No.: PCT/JP2021/019550

§ 371 Date: Oct. 28, 2022

(30) Foreign Application Priority Data
May 29, 2020 (JP) 2020-093869

(51) Int. Cl. F16J 15/3212

(52) U.S. Cl. CPC F16J 15/3212

(57) ABSTRACT

A sealing device is disposed between a rotational shaft and an inner surface of a housing. The sealing device includes a mounted part mounted on the housing; an annular part extending radially inward from the mounted part; an inner cylindrical part supported by the annular part; a seal lip protruding radially inward from the inner cylindrical part, the seal lip brought into slidable contact with the rotational shaft; and a garter spring wound around the inner cylindrical part to compress the seal lip against the rotational shaft. The distance between the boundary between the inner cylindrical part and the annular part and the lip edge of the seal lip along the axial direction of the rotational shaft is equal to or greater than 4 mm. The garter spring applies a force that is equal to or greater than 22 N to the inner cylindrical part.

### CROSS REFERENCE TO RELATED APPLICATIONS

This application is a U.S. National Phase Application under 35 U.S.C. 371 of International Application No. PCT/JP2021/019550, filed on May 24, 2021, which claims priority to Japanese Patent Application No. 2020-093869, filed on May 29, 2020. The entire disclosures of the above applications are expressly incorporated by reference herein.

### BACKGROUND

### Technical Field

The present invention relates to sealing devices.

### Related Art

JP-A-2017-067284 discloses a sealing device that is placed around a crankshaft of an engine of an automotive vehicle and that is used for an oil seal for sealing lubricating oil within a crankcase. JP-A-2017-026073 discloses a sealing device that is placed around a shaft of a differential gear mechanism of an automotive vehicle and that is used for an oil seal for sealing lubricating oil within the housing of the differential gear mechanism.

A lip of the oil seal is brought into slidable contact with the outer peripheral surface of the rotational shaft. Even if the lip is eccentric with respect to the rotational shaft or the outer peripheral surface of the rotational shaft is eccentric with respect to the axis of the rotational shaft, it is desirable that the lip stably follow the outer peripheral surface of the rotational shaft to maintain contact with it and that no gap occur between the lip and the rotational shaft.

High-viscosity oil and low-viscosity oil are known as lubricating oils to be sealed by oil seals. Low-viscosity oil has low frictional resistance, which contributes to improved fuel efficiency of automotive vehicles. In recent years, the use of low-viscosity oil has become predominant to improve fuel economy.

Rubber, which is the raw material of oil seals, loses elasticity, i.e., flexibility, in low-temperature environments, for example, in cold climates. As the flexibility decreases, the ability of the oil seal to follow the rotational shaft decreases.

There is a demand for a lubricating oil having low viscosity (high fluidity) even at low temperatures for smooth starting of rotation of the rotational shaft (e.g., smooth starting an engine) even in a low-temperature environment. Accordingly, a sealing device that prevents oil from leaking from the sealed internal space is desired, even when a low-viscosity oil is used in a low-temperature environment.

### SUMMARY

Accordingly, the present invention provides a sealing device with a superior sealing ability even when a low-viscosity oil is used in a low temperature environment.

In accordance with an aspect of the present invention, there is provided a sealing device adapted to be disposed between a rotational shaft and an inner surface of a housing in which the rotational shaft is located for separating an internal space of the housing from an external space. The sealing device includes a cylindrical mounted part adapted to be mounted on the inner surface of the housing; an annular part extending radially inward from the mounted part toward the rotational shaft; an inner cylindrical part supported by the annular part and located radially inside the mounted part; a seal lip protruding radially inward from an inner peripheral surface of the inner cylindrical part, the seal lip having an internal-side inclined surface having a truncated conical shape and being disposed on a side of the internal space and an external-side inclined surface having a truncated conical shape and being disposed on a side of the external space, the seal lip adapted to be brought into slidable contact with an outer peripheral surface of the rotational shaft; and a garter spring wound around the inner cylindrical part and adapted to compress the seal lip against the outer peripheral surface of the rotational shaft. The distance between the boundary between the inner cylindrical part and the annular part and the lip edge of the seal lip along the axial direction of the rotational shaft is equal to or greater than 4 mm. The garter spring applies a force that is equal to or greater than 22 N to the inner cylindrical part.

In this aspect, the distance between the boundary of the inner cylindrical part and the annular part and the lip edge of the seal lip along the axial direction of the rotational shaft is 4 mm or more. The inner cylindrical part is connected to the annular part at the boundary, and this boundary can be regarded as the fulcrum for the deformation of the seal lip. By increasing the above distance, the bending rigidity of the inner cylindrical part is reduced, and the seal lip can stably follow the outer peripheral surface of the rotational shaft and can easily maintain the contact with it even in a low-temperature environment. On the other hand, by increasing the force exerted by the garter spring on the inner cylindrical part, a gap is less likely to occur between the seal lip and the rotational shaft, and even when a low-viscosity oil is used in a low temperature environment, the oil is unlikely to leak from the internal space.

### BRIEF DESCRIPTION OF THE DRAWINGS

FIG. 1 is a cross-sectional view of a sealing device according to an embodiment of the present invention;

FIG. 2 is a partially cutaway perspective view of the sealing device according to the embodiment of the invention;

FIG. 3 is a graph showing effects of the sealing device according to the embodiment of the invention; and

FIG. 4 is a cross-sectional view of a sealing device according to a modification of the embodiment of the invention.

### DETAILED DESCRIPTION

Hereinafter, with reference to the accompanying drawings, various embodiments according to the present invention will be described. It is of note that the drawings are not necessarily to scale, and certain features may be exaggerated or omitted.

A sealing device according to an embodiment of the present invention is an oil seal that is disposed around a shaft of a differential gear mechanism of an automotive vehicle to seal a lubricating oil within the housing of the differential gear mechanism.

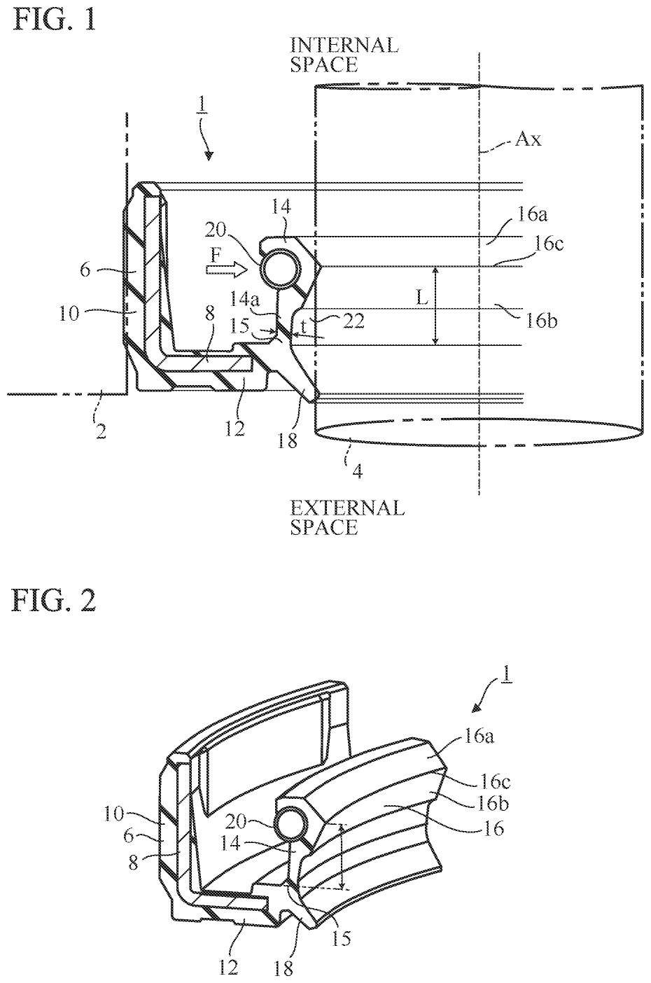

As shown in FIG. 1, the sealing device 1 according to the embodiment of the present invention is disposed between the inner surface of the shaft hole of the housing 2 and the rotational shaft 4 located in the shaft hole, and separates the internal space of the housing 2 from the external space. In other words, the sealing device 1 seals the gap between the housing 2 and the rotational shaft 4 to prevent leakage of lubricating oil within the housing 2. The sealing device 1 is annular about the rotational axis Ax of the rotational shaft 4, but only the left part of the sealing device 1 is shown in FIG. 1.

As shown in FIGS. 1 and 2, the sealing device 1 has a composite structure having an elastic ring 6 made of an elastic material such as an elastomer, and a rigid ring 8 made of a rigid material such as a metal for reinforcing the elastic ring 6. The rigid ring 8 has an L-shaped cross-section. Most of the rigid ring 8 is embedded in the elastic ring 6 and is tightly adhered to the elastic ring 6.

The sealing device 1 has a cylindrical mounted part 10, an annular part 12, an inner cylindrical part 14, a sealing lip 16, and dust lip 18.

The mounted part 10 is mounted on the shaft hole of the housing 2 by, e.g., interference fit. The annular part 12 is coupled to one end of the mounted part 10 and extends radially inward from the mounted part 10 toward the rotational shaft 4.

The mounted part 10 and the annular part 12 are formed from the elastic ring 6 and the rigid ring 8 embedded in the elastic ring 6. The rigid ring 8 enhances the rigidity of the mounted part 10 and the annular part 12.

The inner cylindrical part 14, the seal lip 16, and the dust lip 18 are formed from the elastic ring 6 only.

The inner cylindrical part 14 is located radially inside the mounted part 10 and extends coaxially with the mounted part 10. The inner cylindrical part 14 is supported by the annular part 12. More specifically, one end of the inner cylindrical part 14 is coupled to the inner end of the annular part 12.

The seal lip 16 is a protrusion that is triangular in cross section protruding radially inward from the inner peripheral surface of the inner cylindrical part 14, and is adapted to be brought into slidable contact with the outer peripheral surface of the rotational shaft 4. The seal lip 16 has a truncated conical internal-side inclined surface 16a disposed on the side of the internal space, a truncated conical external-side inclined surface 16b disposed on the side of the external space, and a lip edge 16c disposed at the boundary between the internal-side inclined surface 16a and the external-side inclined surface 16b and extending along a circumferential direction.

The internal-side inclined surface 16a is inclined such that the farther away from lip edge 16c, the farther away from rotational shaft 4. The external-side inclined surface 16b is also inclined such that the farther away from lip edge 16c, the farther away from rotational shaft 4. In the use state of the sealing device 1 in which the sealing device 1 is deployed in the gap between the housing 2 and the rotational shaft 4, the lip edge 16c of the main sealing lip 16 and its vicinity are always brought into slidable contact with the outer peripheral surface of the rotational shaft 4. In this way, the seal lip 16 seals the lubricating oil within the internal space of the housing 2.

Whereas the thick-walled seal lip 16 is formed at the distal end of the inner cylindrical part 14, the proximal portion 14a of the inner cylindrical part 14, which is disposed between the boundary 15 between the inner cylindrical part 14 and the annular part 12 and the seal lip 16, is formed to be thinner. The thin-walled proximal portion 14a reduces the bending rigidity of the inner cylindrical part 14 and improves the followability of the seal lip 16 to the rotational axis 4.

The dust lip 18 is a circular ring that extends diagonally inward in radial directions and toward the external space from the portion of the inner end of the annular part 12 formed only from the elastic ring 6, and is adapted to be brought into slidable contact with the outer peripheral surface of the rotational shaft 4. The dust lip 18 prevents the inflow of foreign matter (e.g., water and dust) from the external space side to the internal space side.

A garter spring 20 is wound around the inner cylindrical part 14. More specifically, a circumferential groove is formed on the outer peripheral surface of the inner cylindrical part 14, and the garter spring 20 is received in this circumferential groove. The garter spring 20 exerts a force F on the inner cylindrical part 14, and presses the seal lip 16, which is disposed radial inside the garter spring 20, against the outer peripheral surface of the rotational shaft 4.

The distance L between the boundary 15 between the inner cylindrical part 14 and the annular part 12 and the lip edge of the seal lip 16 along the axial direction of the rotational shaft 4 is preferably 4 mm or more.

The inner cylindrical part 14 is connected to the annular part 12 at the boundary 15, and this boundary 15 can be regarded as the fulcrum for the deformation of the seal lip 16. By increasing the above distance L, the bending rigidity of the inner cylindrical part 14 is reduced, and the seal lip 16 can stably follow the outer peripheral surface of the rotational shaft 4 and can easily maintain the contact with it even in a low-temperature environment.

The force F exerted by the garter spring 20 on the inner cylindrical part 14 is preferably 22 N or more. By increasing the force F, a gap is less likely occur between the seal lip 16 and the rotational shaft 4, even when a low-viscosity oil is used as lubricating oil in a low temperature environment, the oil is unlikely to leak from the internal space.

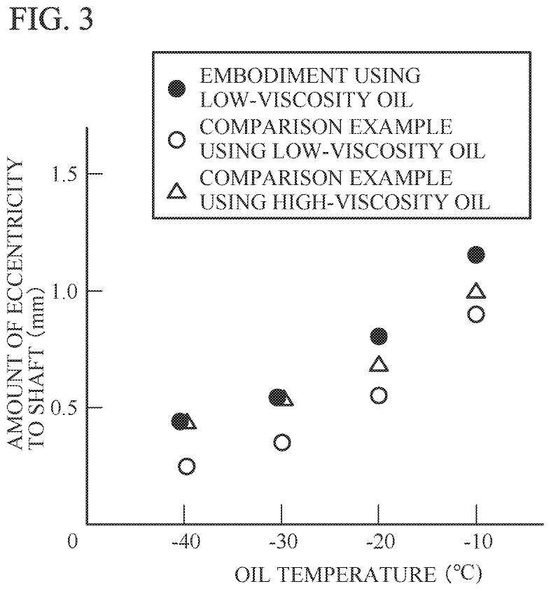

FIG. 3 shows the results of an experiment to confirm the effects of the sealing device 1 according to the embodiment. In the embodiment used in the experiment, the above distance L was 4 mm and the force F was 22 N.

In a comparative example, the distance L was 3.4 mm and the force F was 18 N.

In the embodiment and the comparative example, the diameter of the rotational shaft 4 was 50 mm, and the diameter of the lip edge 16c in the initial state (non-use state) was 48.5 mm. The material of the elastic ring 6 was an acrylic rubber. The thickness t of the thinnest portion of the inner cylindrical part 14 was 0.6 mm, and the outer diameter of the inner cylindrical part 14 at this portion was 53.8 mm.

In the experiment, for both the embodiment and the comparative example, the amount of eccentricity to the shaft ((TIR (Total Indicator Reading)) and the temperature of the lubricating oil were varied, and it was investigated whether or not the lubricating oil leaked from the internal space to the space 22 (the space surrounded by the dust lip 18, the seal lip 16, and the rotational shaft 4) beyond the seal lip 16. The lubricating oils used were low-viscosity oil and high-viscosity oil. In FIG. 3, the maximum amounts of eccentricity to the shaft at which no lubricant leakage occurred were plotted.

As is clear from FIG. 3, the lubricating oil is less likely to leak from the internal space even when the amount of eccentricity to the shaft is large in the embodiment as opposed to the comparative example. In particular, when low-viscosity oil was used, the embodiment was able to reduce the leakage of lubricating oil significantly in comparison with the comparative example. When the oil temperature was −10 degrees Celsius and −20 degrees Celsius, the sealing ability of the embodiment using low-viscosity oil was superior to that of the comparative example using high-viscosity oil. When the oil temperature was −30 degrees Celsius and −40 degrees Celsius, the sealing ability of the embodiment using low-viscosity oil was equivalent to the sealing ability of the comparative example using high-viscosity oil. Thus, according to the embodiment, even when low-viscosity oil is used in a low-temperature environment, the oil is unlikely to leak from the internal space.

In the embodiment used in the experiment, the above distance L was 4 mm and the force F was 22 N. The longer the distance L, the easier it is for the seal lip 16 to follow the outer peripheral surface of the rotational shaft 4. The greater the force F, the less likely it is that a gap will occur between the seal lip 16 and the rotational shaft 4. Therefore, the distance L is preferably 4 mm or more, and the force F is preferably 22 N or more.

### Other Modifications

The present invention has been shown and described with reference to preferred embodiments thereof. However, it will be understood by those skilled in the art that various changes in form and detail may be made without departing from the scope of the invention as defined by the claims. Such variations, alterations, and modifications are intended to be encompassed in the scope of the present invention.

For example, the sealing device according to the above embodiment is an oil seal that is disposed around a shaft of a differential gear mechanism of an automotive vehicle to seal the lubricating oil within the housing of the differential gear mechanism. However, the present invention is not limited to the embodiment, and the sealing device can be used, for example, as an oil seal that is disposed around a crankshaft of an engine of an automotive vehicle to seal a lubricating oil within the crankcase, an oil seal that is disposed around a shaft of a transmission of an automotive vehicle to seal a lubricating oil within the housing of the transmission, and an oil seal that is disposed around the shaft of a motor to seal a lubricating oil within the housing of the motor.

Multiple helical ribs, referred to as “threaded protrusions” disclosed in Japanese Patent No. 3278349, may be formed on the external-side inclined surface 16b of the seal lip 16. The helical ribs exert a pumping action to return liquid from the external space side to the internal space.

Multiple helical ribs inclined in different directions referred to as “forward-directed screw ribs” and “reverse-directed screw ribs” in Japanese Patent No. 4702517 may be formed on the external-side inclined surface 16b of the seal lip 16. In this case, the helical ribs inclined in one direction exert a pumping action to return liquid from the external space side to the internal space when the rotational shaft rotates in a forward direction. The other helical ribs inclined in the other direction exert a pumping action to return liquid from the external space side to the internal space when the rotation shaft rotates in a reverse direction.

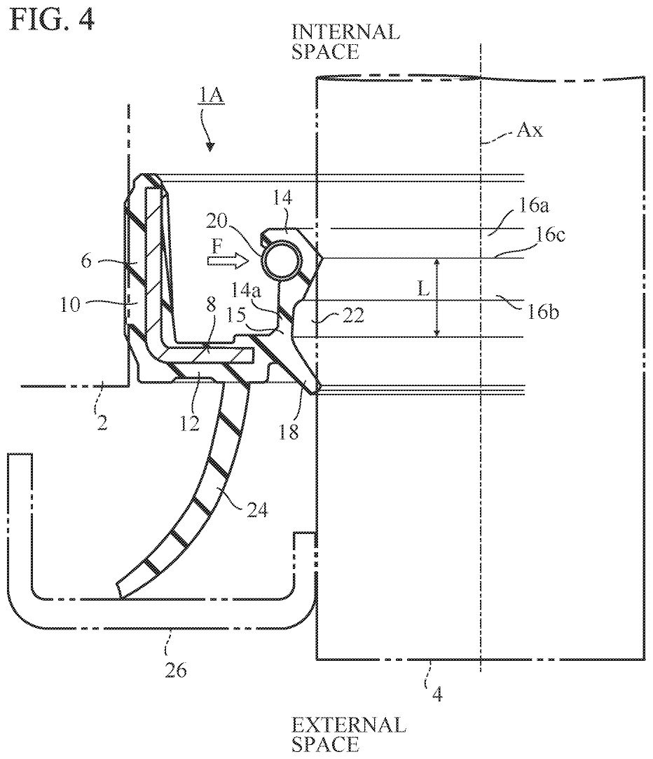

Multiple protrusions disclosed in JP-A-2014-084934, which inhibit excessive deformation of a dust lip, may be formed on the inner peripheral surface of the dust lip 18. When the pressure of the inside space surrounded by the dust lip 18, the seal lip 16, and the rotational shaft 4 (space 22 in FIGS. 1 and 4) becomes negative, such protrusions come temporarily in contact with the outer peripheral surface of the rotational shaft and temporarily create gaps between the distal end of the dust lip 18 and the outer peripheral surface of the rotational shaft. This prevents excessive deformation of the dust lip 18 and an increase in the torque that the dust lip 18 gives to the rotational shaft.

As shown in FIG. 4, a dust cover 26 may be fixed to the rotational shaft 4, and a sealing device 1A according to a modification of the embodiment of the invention may be provided with a side lip 24. The dust cover 26 rotates together with the rotational shaft 4. The side lip 24 is a circular ring extending from the annular part 12 toward the external space side and radially outward, and is formed from the elastic ring 6.

1. A sealing device adapted to be disposed between a rotational shaft and an inner surface of a housing in which the rotational shaft is located for separating an internal space of the housing from an external space, the sealing device comprising:
a cylindrical mounted part adapted to be mounted on the inner surface of the housing;
an annular part extending radially inward from the mounted part toward the rotational shaft;
an inner cylindrical part supported by the annular part and located radially inside the mounted part;
a seal lip protruding radially inward from an inner peripheral surface of the inner cylindrical part, the seal lip having an internal-side inclined surface having a truncated conical shape and being disposed on a side of the internal space and an external-side inclined surface having a truncated conical shape and being disposed on a side of the external space, the seal lip adapted to be brought into slidable contact with an outer peripheral surface of the rotational shaft; and
a garter spring wound around the inner cylindrical part and adapted to compress the seal lip against the outer peripheral surface of the rotational shaft,
a distance between a boundary between the inner cylindrical part and the annular part and a lip edge of the seal lip along an axial direction of the rotational shaft being equal to or greater than 4 mm,
the garter spring applying a force that is equal to or greater than 22 N to the inner cylindrical part.
